(19) United States
(12) Patent Application Publication
(10) Pub. No.: US 2016/0294658 A1
(43) Pub. Date: Oct. 6, 2016

(54) DISCOVERING AND AGGREGATING DATA FROM HUBS

(71) Applicant: Martin Carl FOWLER, Fort Collins, CO (US)

(72) Inventor: Martin Carl FOWLER, Fort Collins, CO (US)

(73) Assignee: CA, INC., New York, NY (US)

(21) Appl. No.: 14/673,070

(22) Filed: Mar. 30, 2015

(51) Int. Cl. H04L 12/26; H04L 12/24

(52) U.S. Cl. CPC H04L 43/0894; H04L 43/045; H04L 43/062; H04L 41/22

(57) ABSTRACT

Systems and methods may include deploying a probe within a network infrastructure. The systems and methods may include discovering, via the probe, hubs within the network infrastructure. The systems and methods may include accessing an interface of each hub and retrieving data from each hub. The systems and methods may include aggregating the data from each hub in a database. The systems and methods may include displaying the aggregated data from each hub in a user interface.

### BACKGROUND

The present disclosure relates to monitoring and data collection and, more specifically, to systems and methods for discovering and aggregating data from hubs.

A probe is a program that may be installed on a robot for the purpose of monitoring or collecting data about network activity, system and application performance, and availability.

A robot is a program that may run on a system and control probe operation, manage probe communication, and pass data and alarms from probes to a hub.

The hub may be the backbone of a unified infrastructure management (UIM) system, which may bind together robots and hubs into a logical structure. The structure may be based on physical network layout, location or organizational structure, but there are generally no restrictions in how the infrastructure is organized. In addition to managing the infrastructure, the hub may also be responsible for: message distribution, name services, tunnel services, security, authentication and authorization. In addition, a hub may include one or more queues therein.

A queue is a holding area for messages passing through a hub. The queues may be temporary or they may be defined as permanent queues. The permanent queues will survive a hub restart and is meant for service probes that need to pick up all messages regardless of whether the service probe is running or not. The temporary queue on the other hand, is cleared during restarts.

### BRIEF SUMMARY

According to an aspect of the present disclosure, a method may include several processes. In particular, the method may include deploying a probe within a network infrastructure. In addition, the method may include discovering, via the probe, a plurality of hubs within the network infrastructure. The method also may include accessing an interface of each hub of the plurality of hubs and retrieving data from each hub. Further, the method may include aggregating the data from each hub in a database. Moreover, the method may include displaying the aggregated data from each hub in a user interface.

Other features and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements.

FIG. 1 is a schematic representation of a network including a plurality of devices, hubs, probes, and other components.

FIG. 2 is a schematic representation of a system configured to implement processes of discovering and aggregating data from hubs.

FIG. 3 illustrates a hub monitoring process.

FIG. 4 illustrates an example of a table showing data about a plurality of hubs in a dashboard-based interface.

FIG. 5 illustrates an example of a table showing data about a plurality of queues in a dashboard-based interface.

FIG. 6 illustrates example charts showing information about the queues that may be accessed by drilling down within the dashboard-based interface.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism fur implementing the functions/acts specified in the flowchart and/or block diagram block or blocks.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference o information technology, systems and methods disclosed herein may be related to any field that may be associated with monitoring communication between devices and/or monitoring the status of devices. Systems and methods disclosed herein may be applicable to a broad range of applications that perform a broad range of processes.

When anomalous events occur in a telecommunication network, network components may become damaged or begin malfunctioning. Consequently, other network components may be unable to communicate with the damaged or malfunctioning components or may receive errant communications (e.g., a flood of data packets from a hacked component, garbled messages from a damaged component, automated alerts from damaged components). For example, as a result of damage to a component, normally-functioning network components may be unable to forward data packets addressed to such damaged component and may be required to queue such data packets until the anomaly has been resolved. As another example, a normally-functioning network component may receive a flood of data packets from a network component that has been hacked or infected by a virus.

When anomalous events occur in a telecommunications network where hubs are located, or when anomalous events occur on a system where a hub is installed, the hub-to-hub message flow may become blocked, and queues may accumulate messages. The blocked messages may contain time-critical metric and alarm data that may convey the status of monitored systems, applications, and networks. Thus, it may be important to quickly identify hubs with blocked messages and take appropriate remedial measures to ensure the adequate performance of monitored systems, applications, and networks.

Certain systems and methods disclosed herein may allow visualizing hub status and performance for all hubs in a deployment in one dashboard. Such information may be available within native interfaces through each hub, but it may be difficult to obtain a holistic view of the status and performance of all hubs. For example, in a 200 hub deployment, the administrator would need to view the interface for every single hub, which is not an efficient (or even feasible) solution given the demands placed on a network administrator and the need to understand the network in a comprehensive manner at all times. The lack of a holistic solution is a challenge for network administrators, as problems with remote hubs may interrupt the flow of time-critical data to the central server.

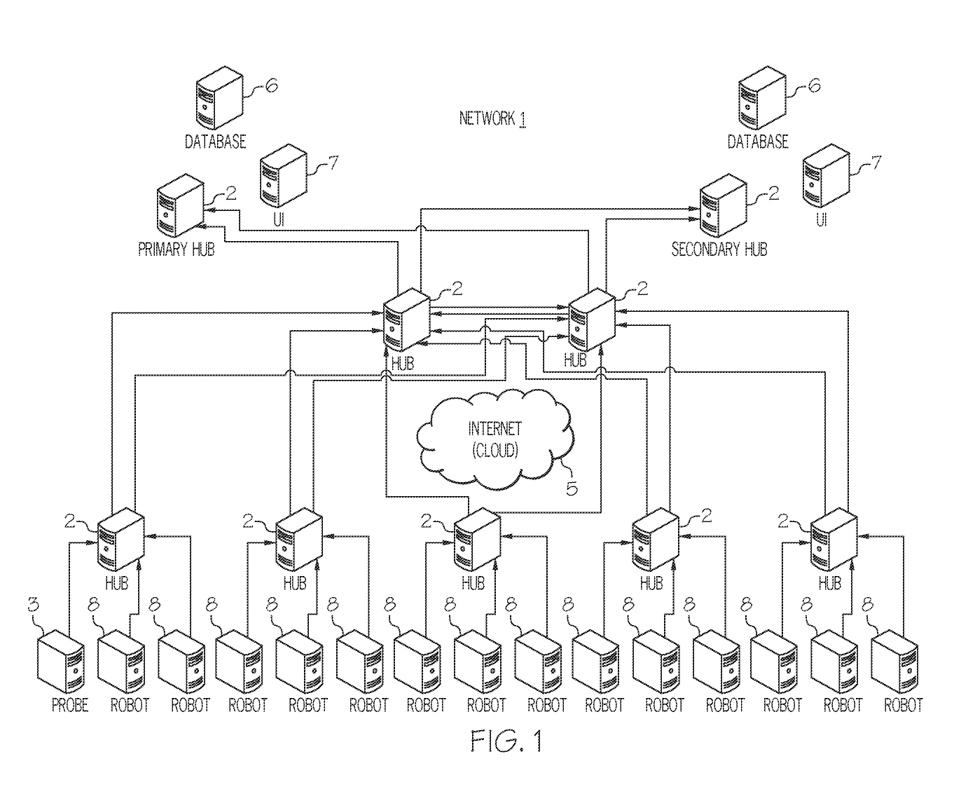

Referring now to FIG. 1, a network 1 including a plurality of hubs 2, probes 3, databases 6, user interfaces 7, robots 8, and other components now is described. Network 1 may connect with and/or include clouds 5 and/or a plurality of network devices (not shown). Clouds 5 may be public clouds, private clouds, or community clouds, for example. Also, network 1 may include one or more of a LAN, a WAN, or another type of network. Moreover, network 1 may include and/or be connected to the Internet. Components within network 1 may be connected wirelessly in addition to or in lieu of wired connections, tier example.

Each cloud 5 may permit the exchange of information and services among users that are connected to such clouds 5. In certain configurations, cloud 5 may be a wide area network, such as the Internet. In some configurations, cloud 5 may be a local area network, such as an intranet. Further, cloud 5 may be a closed, private network in certain configurations, and cloud 5 may be an open network in other configurations. Cloud 5 may facilitate wired or wireless communications of information among users that are connected to cloud 5.

Network 1 may include a plurality of network devices, which may be, for example, one or more of general purpose computing devices, specialized computing devices, mobile devices, wired devices, wireless devices, passive devices, routers, switches, mainframe devices, monitoring devices, infrastructure devices, desktop computers, laptop computers, tablets, phones, wearable accessories, and other devices. Such network devices may communicate by transmitting data packets that include one or more messages, which are processed by a UIM system.

As noted above, network 1 may include a plurality of hubs 2. Hubs 2 may be virtual devices implemented through software running on dedicated hardware, for example. In particular, hubs 2 may function as connection points between components associated with network 1. Each hub 2 may receive data packets (e.g., UIM messages) from one or more robots 8 and/or one or more other hubs 2 and forward such data packets to one or more other robots 8 and/or one or more other hubs 2. Hubs 2 may be established by service functions, for example.

In certain configurations, a hub 2 may queue received messages in one or more queues within such hub 2 prior to sending. For example, hub 2 may have different queues for different types of messages, for messages received from different components or different hubs 2, and/or for messages to be sent to different components or hubs 2. Accordingly, if a hub 2 is unable to forward messages to a component or another hub 2 (e.g., to which such message is addressed or along a specified path) due to an anomaly (e.g., the intended target is offline, busy, or malfunctioning), the total number of messages queued in one or more queues in the hub 2 may increase. Consequently, the total number of messages in a queue may provide valuable information about components within network 1 and/or about network 1 itself.

Network 1 may further include a plurality of probes 3. In some configurations, probes 3 may be selectively deployed throughout network 1 as needed (e.g., when desired, when an anomaly occurs, when it is predicted that an anomaly will likely occur, when a particular event occurs). In other configurations, probes 3 may be permanently deployed within network 1. Probes 3 may be virtual devices implemented through software, for example. Probes 3 may be installed on a particular robot 8, for example Probes 3 may monitor data transmitted within network 1, may discover components within network 1 (e.g., hubs 2), and/or may interface with such components to access and retrieve data from such components (e.g., identifying information for such components, a total number of components in network 1, a total number of queues within a hub 2, identifying information for each queue within a hub 2, a total number of messages sent by a hub 2 since such hub 2 was most-recently activated, a total number of messages received by a hub 2 since such hub 2 was most-recently activated, a total number of messages queued in a hub 2, a total number of messages in a particular queue within a hub 2).

Network 1 may include one or more database 6 that may store and aggregate information corresponding to hubs 2 that was acquired by probe 3. Network 1 also may include a user interface (UI) 7 that may generate a user interface, such as a dashboard, that permits an administrator to efficiently access the information stored in one or more databases 6. In addition, as described above, network 1 may include a plurality of robots 8, which may send UIM messages to hubs 2, and which may receive UIM messages from hubs 2. Robots 8 may manage, probe, and send probe messages to their corresponding hubs 2.

Particular systems and methods disclosed herein may utilize CA UIM hubs, which may be software programs that run on processing systems for the purpose of passing CA UIM messages to a central CA UIM server. In such systems and methods, the probe may similarly be a software program that runs on a robot. Such a probe may be installed in the domain, and all hubs within the domain may be discovered by the probe, regardless of where they reside. Likewise, the robot may also be a software program that manages probes, and sends probe messages to its hub. It may be possible to monitor multiple domains, with one monitoring probe in each domain. Such processing systems may be dedicated devices optimized to execute the hub, probe, and robot software programs, for example. System 100, which is described in more detail below, may be an example of one such processing system.

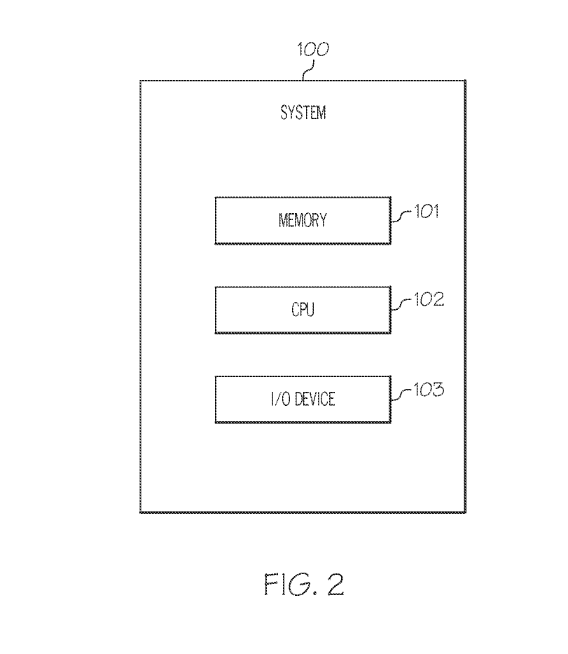

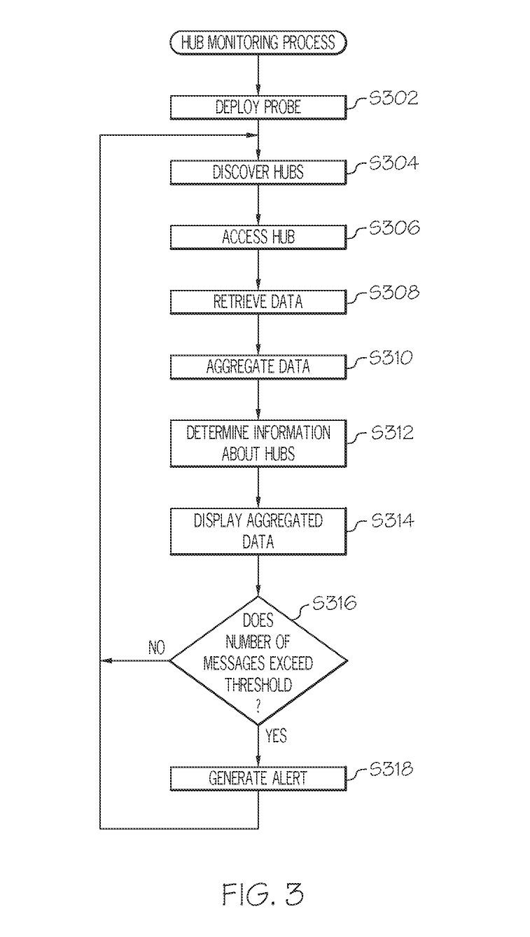

Referring to FIG. 2, system 100 is now described. System 100 may reside on one or more networks 1. System 100 may comprise a memory 101, a central processing unit (“CPU”) 102, and an input and output (“I/O”) device 103. Memory 101 may store computer-readable instructions that may instruct system 100 to perform certain processes. In particular, memory 101 may store computer-readable instructions for performing a hub monitoring process. When such computer-readable instructions are executed by CPU 102, the computer-readable instructions stored in memory 101 may instruct CPU 102 to perform a plurality of functions. Examples of such functions are described below with respect to FIG. 3. System 100 may be used to implement one or more of hubs 2, probe 3, databases 6, UIs 7, and robots 8, as well as other components within network 1.

I/O device 103 may receive one or more of data from networks 1, data from other devices, probes, and sensors connected to system 100, and input from a user and provide such information to CPU 102. I/O device 103 may transmit data to networks 1, may transmit data to other devices connected to system 100, and may transmit information to a user (e.g., display the information, send an e-mail, make a sound). Further, I/O device 103 may implement one or more of wireless and wired communication between system 100 and other devices in network 1 and/or cloud 5.

Referring to FIG. 3, a hub monitoring process now is described.

In S302, system 100 may deploy one or more probes 3 within network 1. In certain implementations, system 100 may deploy such probe(s) 3 in response to a trigger event, for example, such as the occurrence of a specified condition or event, a monitored value nearing or reaching a threshold level, or information about anomalous activity within network 1. In other implementations, system 100 may deploy such probe(s) 3 on a periodic schedule, at predetermined intervals, or permanently when system 100 is activated.

In S304, system 100 may use the deployed probe(s) 3 to discover one or more hubs 2 within network 1. In certain implementations, the deployed probe(s) 3 may discover each active hub 2 within network 1 and determine the total number of active hubs 2 within network 1. For example, system 100 may control such probe(s) 3 to various requests within network 1 and determine the presence of one or more hubs 2 when such hub(s) 2 responds to such requests.

In S306, system 100 may control one or more of the deployed probes 3 to access the interface of one or more of the discovered hubs 2. In particular, probe(s) 3 may interface with each hub 2 and begin communicating with such hubs 2.

In S308, system 100 may control probe(s) 3 to retrieve data from the hub(s) 2 with which such probe(s) 3 have interfaced. In particular, a probe 3 may perform a callback operation to retrieve data from a hub 2. Such data may include, for example, one or more of identifying information for hub 2, a total number of queues within hub 2, identifying information for each queue within hub 2, a total number of messages sent by hub 2 in a given period of time, a total number of messages received by hub 2 in a given period of time, a total number of messages queued in hub 2, and a total number of messages in each queue within hub 2.

In S310, system 100 may aggregate the data retrieved from hub(s) 2. In particular, system 100 may store the retrieved data (e.g., retrieved in S308) in a database. The database may be a local component of system 100, a remote component, such as a server or other external storage medium, or some combination thereof. In certain implementations, system 100 may organize the aggregated data based on a plurality of parameters, such as one or more of the hub 2 from which such data was retrieved, the queue associated with such data, the type of queue associated with such data, the type, function, and/or importance of message(s) and/or data packet(s) associated with such data, and the time at which such data was retrieved, for example.

In S312, system 100 may access the aggregated data stored in the database and determine characteristic information about the hubs. For example, system 100 may use the total number of messages received by a hub 2 in a given period of time to determine an incoming message rate, which is a rate at which messages come into the hub 2, and/or system 100 may use the total number of messages sent by the hub 2 in the given period of time to determine an outgoing message rate, which is a rate at which messages leave the hub 2. Such information may be useful to determine whether the hub is infected with a virus, has been hacked (e.g., is being used to implement a denial of service-type attack in which the hub 2 blasts other network components with an overwhelming number of outgoing messages), or is under attack (e.g., by a denial of service-type attack that may be overwhelming the hub 2 with incoming messages). As another example, system 100 may use the aggregated data to determine the total number of messages queued in similar queues in a plurality of hubs 2. If this total number is high, it may suggest that a component at the forwarding address for such messages may be malfunctioning or otherwise behaving anomalously. In some implementations, a variety of characteristic information about the hubs may be determined, such as, for example, message rates for the hub as a whole, per-queue message rates, queue bulk size, queue size, queue connected status, hub version and build, hub log level, hub availability, and/or hub uptime.

In S314, system 100 may organize the aggregated data into a structured format and control a display (not shown) to display the aggregated data in the structured format within a user interface. This may permit an administrator or other user to view information about the network 1 and, in particular, information about the hubs 2. System 100 also may control the display to display one or more pieces of characteristic information determined in S312.

The user interface may permit an administrator to view the network 1 and the hubs 2 at a plurality of levels. For example, the user interface may present a network-level view of the network 1 that displays the total number of hubs 2 within the network 1, the total number of messages queued in the network 1, average incoming and outgoing message rates for the network 1, and/or total number of different queues within the network 1, as well as other information. The network-level view also may include a list of the hubs 2 in the network 1, including corresponding identifiers for each hub 2. This list also may include summary information about each hub 2. When an administrator or other user selects one of the hubs 2 in the network-level view, the user interface may present a hub-level view of the selected hub 2 that displays the total number of queues within the hub 2, the total number of messages queued in the hub 2, average incoming and outgoing message rates for the hub 2, as well as other information. The hub-level view also may include a list of the queues in the hub 2, including corresponding identifiers for each queue. When an administrator or other user selects one of the queues in the hub-level view, the user interface may present a queue-level view of the selected queue that displays the total number of messages queued in the queue, average incoming and outgoing message rates for the queue, as well as other information. Consequently, the user interface may permit the administrator to drill-down into the network 1 and learn about the network 1 at a plurality of levels.

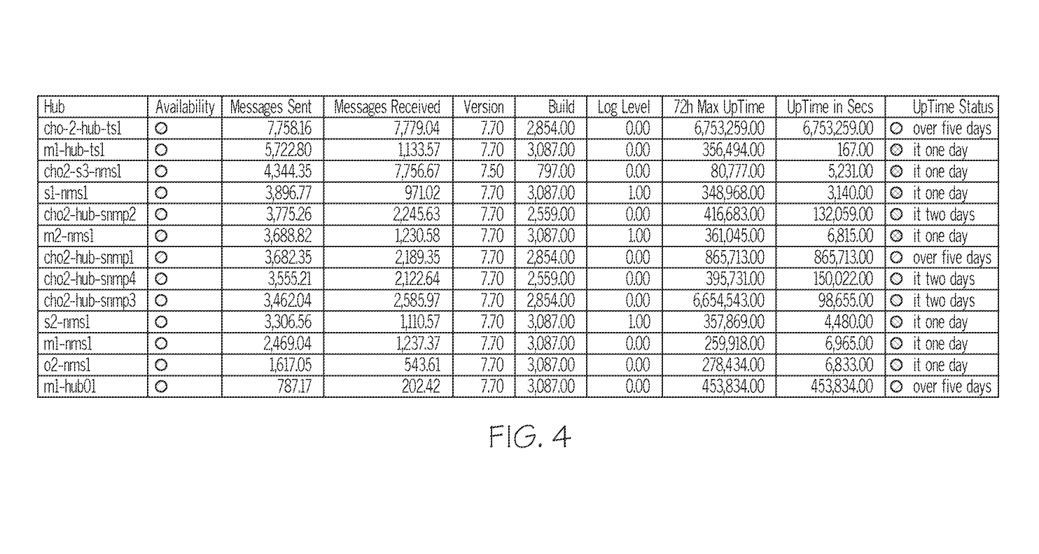

The user interface may include a centralized dashboard that permits network administrators to easily access information about all hubs and all queues within a deployment and to drill down to obtain more specific information as needed. FIGS. 4-6 (described in more detail below) show example tables and charts that may be presented within the user interface.

In S316, system 100 may determine whether the number (or rate) of messages associated with a hub 2 (or associated with a particular queue within a hub 2) is unusual. For example, system 100 may use the aggregated data to determine whether the total number of messages queued in a hub 2 (or queued in a particular queue within the hub 2) exceeds a threshold value, which may correspond to a predetermined number of messages that indicates a likely anomaly. In another example, system 100 may use the aggregated data to determine whether the total number of messages sent by a hub 2 (or sent from a particular queue within the hub 2) within a particular period of time (e.g., since the hub 2 was last activated, over the last hour, since the hub was first activated) exceeds a threshold value, which may similarly correspond to a predetermined number of messages that indicates a likely anomaly. In yet another example, system 100 may use the aggregated data to determine whether the total number of messages received by a hub 2 (or received in a particular queue within the hat) 2) within a particular period of time (e.g., since the hub 2 was last activated, over the last hour, since the hub was first activated) exceeds a threshold value, which may likewise correspond to a predetermined number of messages that indicates a likely anomaly. Alternatively, system 100 may use a message rate, rather than a total number of messages, to make such determinations. When the threshold has been exceeded, system 100 may determine that the number (or rate) of messages associated with a hub 2 (or associated with a particular queue within a hub 2) is unusual.

When system 100 determines that the number (or rate) of messages associated with a hub 2 (or associated with a particular queue within a hub 2) is unusual (S316: Yes), the process may proceed to S318, and system 100 may generate an alert indicating a potential anomaly. The alert may be presented through the user interface or through another means, such as an e-mail, a text message, and/or a phone call, for example, and may identify characteristic information about the potential anomaly, such as an identifier for the hub 2 and/or the queue, the number (or rate) of messages that triggered the alert, the type of messages that triggered the alert (e.g., incoming, outgoing, queued), and/or other information about the potential anomaly. After presenting the alert, the process may return to S304, and the probe(s) 3 may repeat the process of discovering hub(s) 2.

When system 100 determines that the number (or rate) of messages associated with a hub 2 (or associated with a particular queue within a hub 2) is not unusual (S316: No), the process may return to S304, and the probe(s) 3 may repeat the process of discovering hub(s) 2.

Consequently, once a probe has been deployed and activated, system 100 may use a probe 3 to discover hubs 2 as such hubs 2 are activated and to periodically aggregate data related to data packets received by, transmitted from, and/or queued within such hubs 2, such that system 100 is able to monitor network 1 and identify anomalies in a timely and efficient manner.

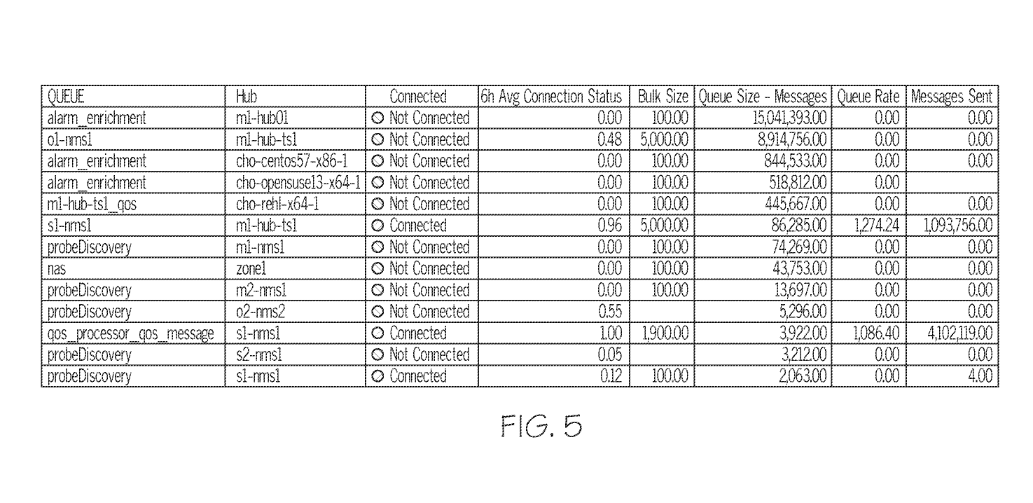

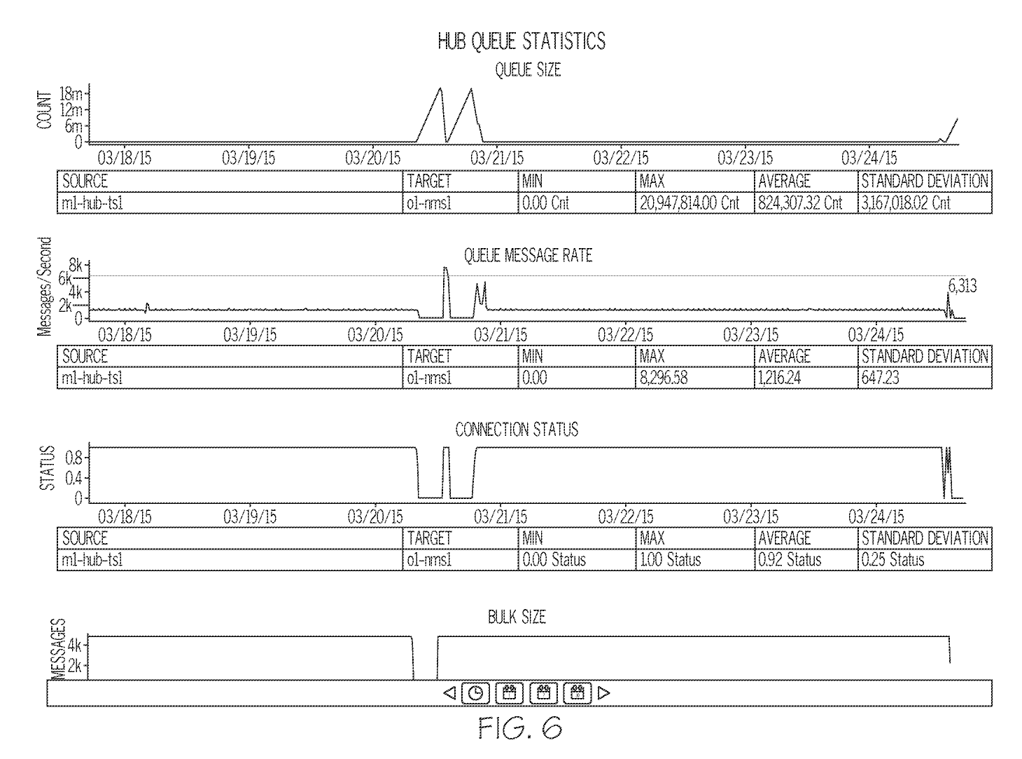

Particular implementations of a monitoring probe disclosed herein may use the UIM product API to discover all hubs in a network deployment and thereafter access each hub then on a configurable interval (e.g., default 60 second intervals) to gather the each hub's metrics. Rates may be calculated for hub and per-queue messages sent. The retrieved metrics and rates may be published to a database, such as a Nimsoft/UIM database. A dashboard may be created in conjunction with such data aggregation, and the dashboard may present table views of all hub data, such as the table shown in FIG. 4, and table views of all queue data, such as the table shown in FIG. 5. The data presented in the table views may be sortable by any of the collected metrics, and the tables and/or dashboard may provide an interface including the ability to drill-down for time-series views for particular metrics, such as the chart for a particular queue shown in FIG. 6. The dashboard may be part of a web-based user interface, for example. The tables and charts shown in FIGS. 4-6 represent an example implementation in which there are over 100 hubs, and over 1,000 queues represented. For such an example implementation, sorting on queue size in the table of queue data shown in FIG. 5 may show the administrator if there are any queues among all 1,000 across all 100 hubs that are accumulating messages and warrant further investigation.

A powerful aspect of systems and methods disclosed herein is that, by Virtue of its collecting all hub data fur all hubs in a domain from one probe, the probe may be situated in the deployment domain such that the probe's published data flow to another UIM server dedicated to monitoring the primary production UIM server. Consequently, the probe may be used to efficiently monitor UIM systems.

The flowcharts and diagrams in FIGS. 1-3 illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

What is claimed is:

1. A method comprising:
deploying a probe within a unified infrastructure management (UIM) system;
discovering, via the probe, a plurality of hubs within the UIM system, each hub passing only UIM traffic;
accessing an interface of each hub of the plurality of hubs and retrieving data from each hub;
aggregating the data from each hub in a database; and
displaying the aggregated data from each hub in a user interface, the user interface providing access to data aggregated from all of the hubs of the plurality of hubs with central visualization.

2. The method of claim 1, wherein accessing the interface of each hub of the plurality of hubs and retrieving data from each hub comprises discovering a total number of queues present in each hub.

3. The method of claim 2, wherein accessing the interface of each hub of the plurality of hubs and retrieving data from the hub further comprises discovering an identifier for each queue present in the hub.

4. The method of claim 1, wherein the data retrieved from each hub comprises:
a total number of messages sent by the hub since the hub was activated,
a total number of messages received by the hub since the hub was activated, and
a total number of messages sent for each queue since the hub was activated.

5. The method of claim 4, wherein the data retrieved from each hub further comprises a total number of messages in each queue present in the hub.

6. The method of claim 5, further comprising:
determining whether the total number of messages in a queue present in the hub is greater than a threshold value; and
in response to determining that the total number of messages in the queue present in the hub is greater than the threshold value, generating an alert indicating that the total number of messages in the queue present in the hub is greater than the threshold value.

7. The method of claim 1, further comprising:
determining an incoming message rate, which is a rate at which messages come into the hub; and
determining an outgoing message rate, which is a rate at which messages leave the hub; and
determining an outgoing message rate for each queue,
wherein displaying the aggregated data from each hub in the user interface comprises displaying the incoming message rate, the outgoing message rate, and the outgoing message rate for each queue.

8. A system comprising:
a processing system configured to:
deploy a probe within a unified infrastructure management (UIM) system;
discover, via the probe, a plurality of hubs within the UIM system, each hub passing only UIM traffic;
access an interface of each hub of the plurality of hubs and retrieve data from each hub;
aggregate the data from each hub in a database; and
display the aggregated data from each hub in a user interface, the user interface providing access to data aggregated from all of the hubs of the plurality of hubs with central visualization.

9. The system of claim 8, wherein, when accessing the interface of each hub of the plurality of hubs and retrieving data from each hub, the processing system is configured to discover a total number of queues present in each hub.

10. The system of claim 9, wherein, when accessing the interface of each hub of the plurality of hubs and retrieving data from each hub, the processing system is configured to:
discover an identifier for each queue present in the hub.

11. The system of claim 8, wherein the data retrieved from each hub comprises:
a total number of messages sent by the hub since the hub was activated,
a total number of messages received by the hub since the hub was activated, and
a total number of messages sent for each queue since the hub was activated.

12. The system of claim 11, wherein the data retrieved from each hub further comprises a total number of messages in each queue present in the hub.

13. The system of claim 12, wherein the processing system is further configured to:
determine whether the total number of messages in a queue present in the hub is greater than a threshold value; and
in response to determining that the total number of messages in the queue present in the hub is greater than the threshold value, generate an alert indicating that the total number of messages in the queue present in the hub is greater than the threshold value.

14. The system of claim 8,
wherein the processing system is further configured to:
determine an incoming message rate, which is a rate at which messages come into the hub; and
determine an outgoing message rate, which is a rate at which messages leave the hub, and
wherein, when displaying the aggregated data from each hub in the user interface, the processing system is configured to:
display the incoming message rate and the outgoing message rate.

15. A computer program product comprising:
a computer readable storage medium having computer readable program code embodied therewith, the computer readable program code comprising:
computer readable program code configured to deploy a probe within a unified infrastructure management (UIM) system;
computer readable program code configured to discover, via the probe, a plurality of hubs within the UIM system, each hub passing only UIM traffic;
computer readable program code configured to access an interface of each hub of the plurality of hubs and retrieve data from each hub;
computer readable program code configured to aggregate the data from each hub in a database; and
computer readable program code configured to display the aggregated data from each hub in a user interface, the user interface providing access to data aggregated from all of the hubs of the plurality of hubs with central visualization

16. The computer program product of claim 15, wherein the computer readable program code configured to access the interface of each hub of the plurality of hubs and retrieve data from each hub comprises:
computer readable program code configured to discover a total number of queues present in each hub; and
computer readable program code configured to discover an identifier for each queue present in the hub.

17. The computer program product of claim 15, wherein the data retrieved from each hub comprises:
a total number of messages sent by the hub since the hub was activated,
a total number of messages received by the hub since the hub was activated, and
a total number of messages sent for each queue since the hub was activated.

18. The computer program product of claim 17, wherein the data retrieved from each hub further comprises a total number of messages in each queue present in the hub.

19. The computer program product of claim 18, wherein the computer readable program code further comprises:
computer readable program code configured to determine whether the total number of messages in a queue present in the hub is greater than a threshold value; and
computer readable program code configured to, in response to determining that the total number of messages in the queue present in the hub is greater than the threshold value, generate an alert indicating that the total number of messages in the queue present in the hub is greater than the threshold value.

20. The computer program product of claim 15,
wherein the computer readable program code further comprises:
computer readable program code configured to determine an incoming message rate, which is a rate at which messages come into the hub; a
computer readable program code configured to determine an outgoing message rate, which is a rate at which messages leave the hub; a
computer readable program code configured to determine an outgoing message rate for each queue; which is a rate at which messages leave each queue and
wherein the computer readable program code configured to display the aggregated data from each hub in the user interface comprises:
computer readable program code configured to display the incoming message rate, the outgoing message rate, and the outgoing message rate for each queue.
